(19) United States
(12) Patent Application Publication
(10) Pub. No.: US 2026/0156496 A1
(43) Pub. Date: Jun. 4, 2026

(54) WI-FI GATEWAY AND EXTENDER PLACEMENT OPTIMIZATION

(71) Applicant: MaxLinear, Inc., Carlsbad, CA (US)

(72) Inventors: Saju Palayur, Poway, CA (US); Sanjay P. Bapat, San Diego, CA (US); Khan M. Muneer, San Diego, CA (US)

(73) Assignee: MaxLinear, Inc., Carlsbad, CA (US)

(21) Appl. No.: 19/405,323

(22) Filed: Dec. 1, 2025

Related U.S. Application Data
(60) Provisional application No. 63/726,659, filed on Dec. 1, 2024.

(51) Int. Cl. H04W 24/02; H04W 24/08; H04W 84/12

(52) U.S. Cl. CPC H04W 24/02; H04W 24/08; H04W 84/12

(57) ABSTRACT

An access point (AP) may include a transceiver and a processing device. The processing device may be operable to obtain, from the transceiver, multiple received signal strength indicators (RSSIs) from multiple devices in an area. The processing device may also be operable to generate a mapping of wireless local area network (WLAN) performance across the area using the multiple RSSIs. The processing device may further be operable to generate a user instruction based on the mapping.

### CROSS REFERENCE TO RELATED APPLICATIONS

This U.S. Patent Application claims priority to U.S. Provisional Patent Application No. 63/726,659, titled “WI-FI GATEWAY AND EXTENDER PLACEMENT OPTIMIZATION,” and filed on December 1, 2024, the disclosure of which is hereby incorporated by reference in its entirety.

### TECHNICAL FIELD

This disclosure generally relates to wireless communication and networking, and more specifically, to placement optimization of a Wi-Fi® Gateway and/or an extender.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, an access point (AP) may include a transceiver and a processing device. The processing device may be operable to obtain, from the transceiver, multiple received signal strength indicators (RSSIs) from multiple devices in an area. The processing device may also be operable to generate a mapping of wireless local area network (WLAN) performance across the area using the multiple RSSIs. The processing device may further be operable to generate a user instruction based on the mapping.

In another embodiment, a station may include a transceiver, a processing device, and a speaker. The processing device may be operable to obtain a user instruction based on a mapping of wireless local area network (WLAN) performance across an area. The user instruction may be obtained from the transceiver and may be transmitted by an access point (AP). The mapping may be based on multiple received signal strength indicators (RSSIs) from multiple devices in the area. The speaker may be operable to provide the instruction as voice-guided feedback.

In another embodiment, a method may include receiving, at an access point (AP), multiple received signal strength indicators (RSSIs) from multiple devices in an area. The method may also include generating, at the AP, a mapping of wireless local area network (WLAN) performance across the area using the multiple RSSIs. The method may further include generating, at the AP, a user instruction based on the mapping.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example system for Wi-Fi® gateway and extender placement optimization;

FIG. 2 illustrates a flowchart of an example method for Wi-Fi® gateway and extender placement optimization;

FIG. 3 illustrates a flowchart of another example method for Wi-Fi® gateway and extender placement optimization;

FIG. 4 illustrates a block diagram of an example communication system for Wi-Fi® gateway and extender placement optimization; and

FIG. 5 illustrates an example computing device.

### DETAILED DESCRIPTION

Wireless architecture, such as a local wireless area network (WLAN), may include various components such as access points (APs), wireless extenders, and stations (STAs). Because of interference and signal degradation, a proper placement of the AP and/or the wireless extender in the WLAN may have an effect on signal performance. In many cases, determining the proper placement and/or orientation of the AP and/or wireless extender may involve trial-and-error, which may be time-consuming and/or inaccurate. Additionally, interference and signal degradation may change over time. Therefore, the placement and orientation of the AP and/or wireless extender may be changed constantly in order to match the prevailing network conditions.

The system described in the present disclosure may combine RSSI mapping, CSI (Channel State Information), and/or beamforming data to optimize Wi-Fi® gateway and extender placement. The system described herein may provide voice-guided feedback through a phone application and/or other device to guide users in locating the AP and/or the wireless extender which may improve signal coverage. By combining RSSI mapping, CSI analysis, and/or beamforming optimization, the system may provide a robust, user-friendly solution for maximizing Wi-Fi® coverage. Voice-guided feedback may contribute to non-technical users improving their network performance.

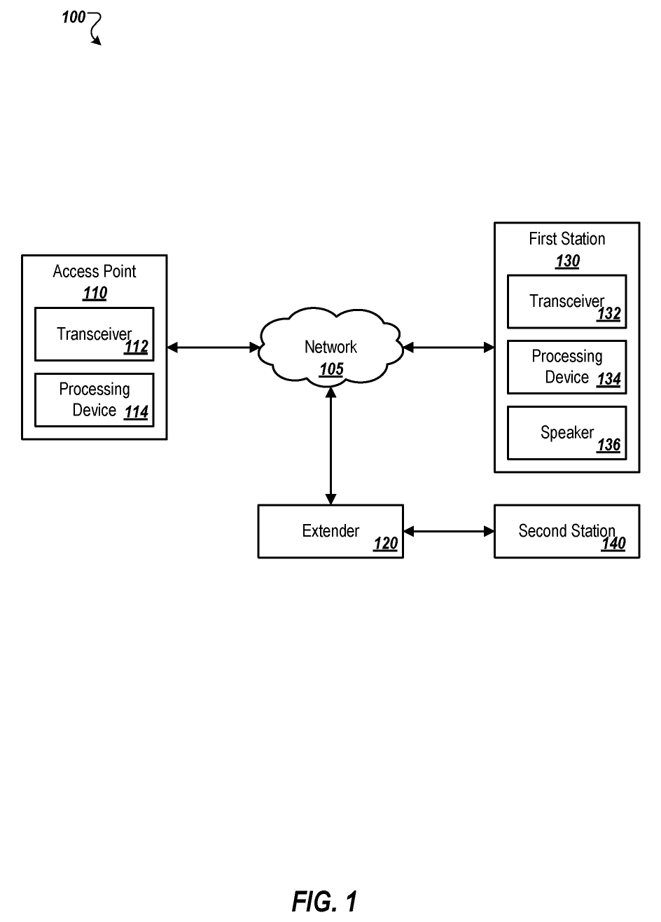

FIG. 1 illustrates an example system 100 for Wi-Fi® gateway and extender placement optimization. The system 100 may include a network 105, an access point (AP) 110, an extender 120, a first station (STA) 130, and a second STA 140. The AP 110 may include a transceiver 112 and a processing device 114. The first STA 130 may include a transceiver 112, a processing device 134, and a speaker 136.

Similarly numbered reference numbers and/or similarly named elements in the figures may represent the same of similar element, and/or elements that may be operable to perform the same or similar operations. For example, the first STA 130 and the second STA 140 in FIG. 1 may be similar stations and/or may be operable to perform substantially the same operations, unless stated otherwise. Alternatively, or additionally, the transceiver 112 and the processing device 114 of the AP 110 may be the same or similar as the transceiver 132 and the processing device 134 of the first STA 130 and/or may be operable to perform substantially the same operations, unless stated otherwise.

In some instances, the network 105 may be a wireless network, such as a WLAN. The network 105 may support wireless communications between connected devices using a mutually supported standard, such as 802.11a, 802.11b, 801.11g, 802.11n (Wi-Fi® 4), 802.11ac (Wi-Fi® 5), 802.11ax (Wi-Fi® 6), and so forth. As illustrated, the AP 110 may connect to the first STA 130 via the network 105. Alternatively, or additionally, the AP 110 may connect with a station via the network 105 and the extender 120, such as the second STA 140. In such instances, the second STA 140 may connect with the extender 120 using a wireless connection and the extender 120 may connect with the AP 110 using the network 105.

The processing device 114 may obtain multiple received signal strength indicator (RSSI) data from one or more devices in an area, such as an area where the system 100 may be located. The area may include a room, a space, and/or a location in which the network 105 may facilitate communications between connected devices, such as the AP 110, the first STA 130, and/or the second STA 140. Alternatively, or additionally, the area may be extended to a larger area using the extender 120. In some instances, the area may include any devices connected to the AP 110 via the network 105. In some instances, the processing device 114 may generate a mapping of wireless local area network (WLAN) performance across the area using the multiple RSSI data.

In some instances, the processing device 114 may collect real-time signal strength data from the connected devices. Alternatively, or additionally, the processing device 114 may collect the real-time signal strength data from dedicated scanning tools connected to the network 105. The processing device 114 may be operable to generate a heat-map of Wi-Fi® performance for the area. In some instances, the heat-map may contribute to identifying weak signal zones and potential dead spots within the area.

The processing device 114 may receive channel state information (CSI) data from the one or more devices in the area. Using the CSI data, the processing device 114 may generate the mapping of WLAN performance across the area. The CSI data may be a detailed metric from the Wi-Fi® specifications. In some instances, the processing device 114 may use the CSI data to analyze the channel conditions, which may include multipath effects and/or interference in the area. In some instances, the CSI data may provide a deeper understanding of signal quality and the interaction between the signal (and the quality thereof) and the environment included in the area, such as walls and/or furniture.

In some instances, the processing device 114 may receive beamforming feedback from one or more of the devices in the area. Using the beamforming feedback, the processing device 114 may generate the mapping of WLAN performance across the area using the beamforming feedback. In some instances, the processing device 114 may integrate the beamforming feedback to optimize signal directionality in the system 100. By analyzing beamforming feedback, the processing device 114 may identify efficient angles and/or adjustments to the elements in the system 100 to improve signal reach and/or reduce interference.

Using one or more of the RSSI data, the CSI data, and/or the beamforming feedback, the processing device 114 may be operable to determine a placement for one or more of the AP 110 and/or the extender 120. For example, the processing device 114 may integrate one or more of the RSSI data, the CSI data, and/or the beamforming feedback to determine where the AP 110 and/or the extender 120 may be positioned within the area to optimize performance of the system 100.

In some instances, the processing device 114 may be operable to determine a confirmation that a placement of a device (e.g., the first STA 130) has been provided. For example, a user may place the AP 110 and/or the extender 120 at a location as instructed by the processing device 114, and the processing device 114 may confirm that the AP 110 and/or the extender 120 was placed and/or positioned to optimize performance (e.g., in accordance with the instructions from the processing device 114).

In some instances, the processing device 114 may be operable to automatically determine when a change may have occurred within the area. The change may include one or more of a new device joining the network 105, an environmental change (e.g., relocation, addition, and/or removal of objects in the area), and a change in usage pattern of devices in the system 100. The processing device 114 may be operable to continuously monitor network conditions and may be operable to update recommendations due to determined changes.

In some instances, the processing device 114 may be operable to provide a user instruction to one of the first STA 130 and/or the second STA 140. For example, a user of the first STA 130 may receive the user instruction on an application associated with the first STA 130 (e.g., a phone app when the first STA 130 is a mobile phone). In some instances, the user instruction may include voice-guided feedback, which may be used to direct the user to locate the AP 110 and/or the extender 120 to the determined placement.

For example, the user instruction may include operation-by-operation voice-guided instructions to the user, based on the RSSI data, the CSI data, and/or the beamforming feedback. For example, the user instruction may include voice-guided instructions such as “move the extender two feet to the left to reduce interference” and/or “rotate the access point approximately 30 degrees for better beam alignment with the devices.” In some instances, the processing device 114 and/or the app (e.g., the processing device 134 on the first STA 130) may be operable to monitor real-time changes in the area as the devices and/or the environment changes. Alternatively, or additionally, the processing device 114 and/or the app may be operable to confirm when the optimal placement of the AP 110 and/or the extender 120 may have been accomplished.

In some instances, the processing device 134 of the first STA 130 may be operable to obtain a user instruction, as described, which may be based on the mapping of the WLAN performance in the area. The processing device 134 may obtain the user instruction from the transceiver 132, which transmission may be obtained from the AP 110. As described, the mapping may be based on one or more of the RSSI data, the CSI data, and/or the beamforming feedback.

In some instances, the processing device 134 may be operable to verify when placement of the AP 110 and/or the extender 120 may have been accomplished. The speaker 136 in the first STA 130 may be operable to provide the voice-guided feedback. For example, the voice-guided feedback may be provided via an application on the first STA 130 (e.g., a mobile phone) and may be played using the speaker 136.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

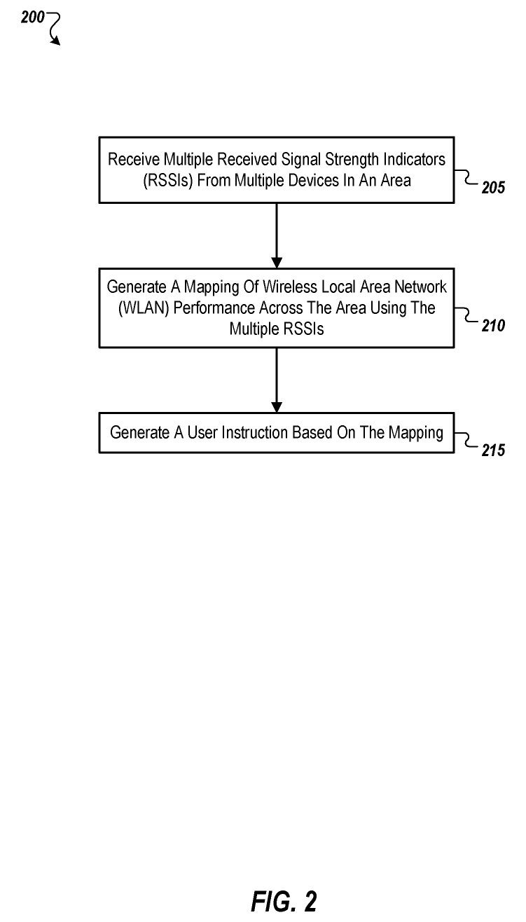

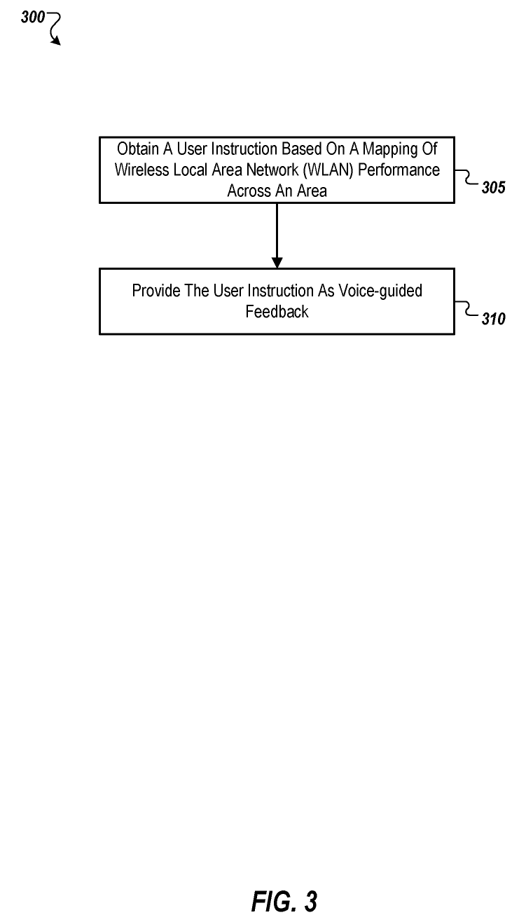

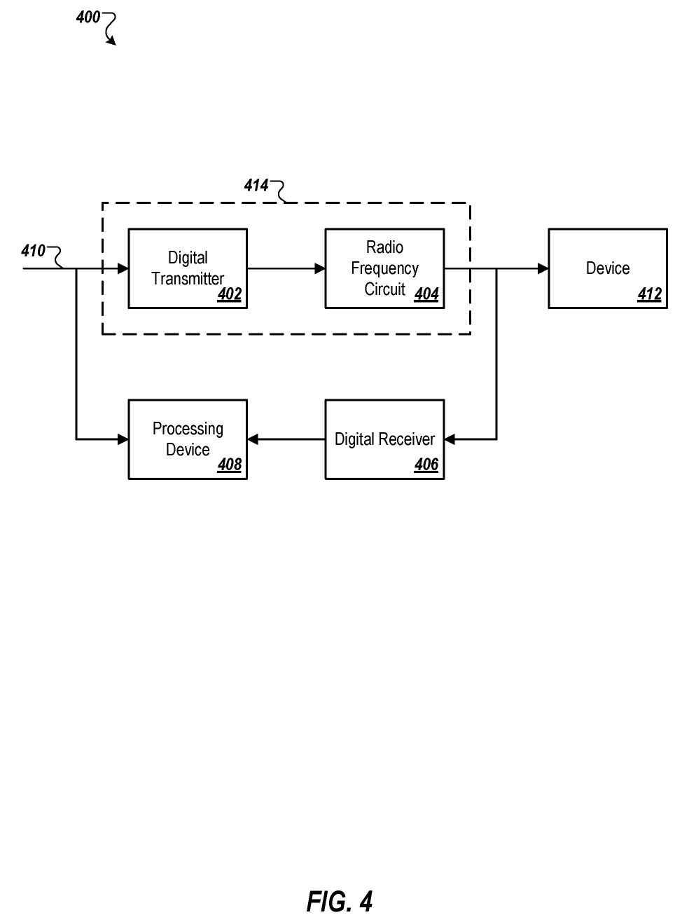

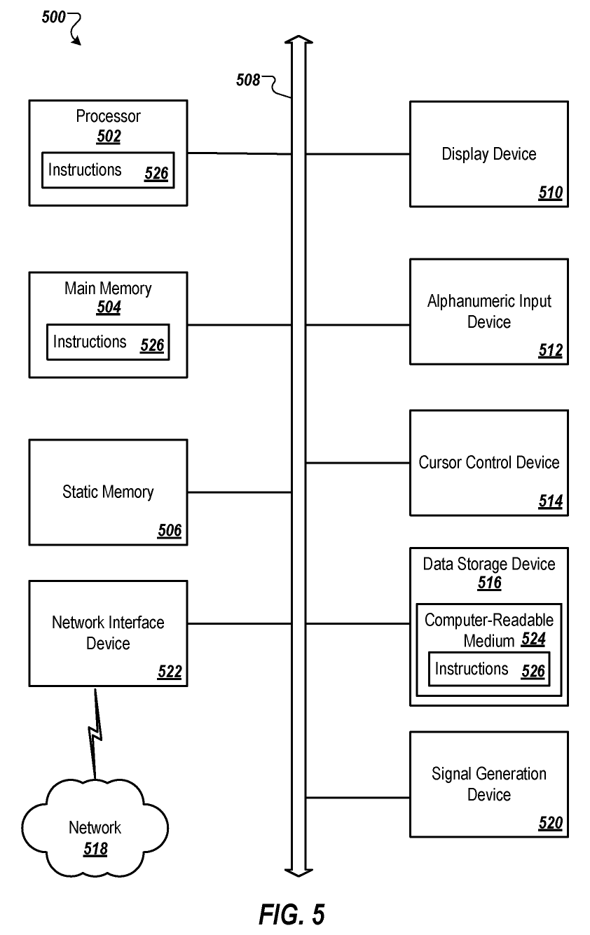

FIGS. 2 and 3 illustrate methods 200 and 300, respectively, which may be performed by processing logic that may include hardware (circuitry, dedicated logic, etc.), software (such as is run on a general purpose computer system or a dedicated machine), or a combination of both, which processing logic may be included in any computer system or device such as the AP 110 of FIG. 1, the communication system 400 of FIG. 4, and/or the processing device 502 of FIG. 5.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 2 illustrates a flowchart of an example method 200 for Wi-Fi® gateway and extender placement optimization. The method 200 may begin at block 205 where the processing logic may receive multiple received signal strength indicators (RSSIs) from multiple devices in an area. The RSSIs may be received at an AP.

At block 210, the processing logic may generate a mapping of WLAN performance across the area using the multiple RSSIs. The mapping may be generated at the AP.

At block 215, the processing logic may generate a user instruction based on the mapping. The user instruction may be generated at the AP.

Modifications, additions, or omissions may be made to the method 200 without departing from the scope of the present disclosure. For example, the processing logic may receive CSI data from the multiple devices in the area, where the CSI data may be received at the AP. The processing logic may generate the mapping of WLAN performance across the area using the CSI data.

In another example, the processing logic may receive beamforming feedback from the multiple devices in the area, where the beamforming feedback may be received at the AP. The processing logic may generate the mapping of WLAN performance across the area using the beamforming feedback.

In another example, the processing logic may determine a placement for one or more of the AP or a wireless extender. The placement may be determined at the AP. Alternatively, or additionally, the processing logic may determine confirmation that the placement has been provided.

In another example, the processing logic may identify when a change may have occurred. The change may be identified at the AP. The change may include one or more of a new device joining the WLAN, an environmental change, and/or a usage pattern change.

In another example, the processing logic may provide the user instruction to a STA. In another example, the designations of different elements in the manner described is meant to help explain concepts described herein and is not limiting. Further, the method 200 may include any number of other elements or may be implemented within other systems or contexts than those described.

FIG. 3 illustrates a flowchart of an example method 300 for Wi-Fi® gateway and extender placement optimization. The method 300 may begin at block 305 where the processing logic may obtain a user instruction based on a mapping of WLAN performance across an area. The user instruction may be obtained at a STA and/or may be obtained from an AP. The mapping may be based on multiple RSSIs from multiple devices in an area. Alternatively, or additionally, the mapping may be based on CSI data from the multiple devices in the area. Alternatively, or additionally, the mapping may be based on beamforming feedback from the multiple devices in the area.

At block 310, the processing logic may provide the user instruction as voice-guided feedback. In some instances, the processing logic may verify when placement of one or more of the AP or the extender may have been provided. In some instances, the voice-guided feedback may be provided via a phone application.

Modifications, additions, or omissions may be made to the method 200 without departing from the scope of the present disclosure. For example, the designations of different elements in the manner described is meant to help explain concepts described herein and is not limiting. Further, the method 300 may include any number of other elements or may be implemented within other systems or contexts than those described.

FIG. 4 illustrates a block diagram of an example communication system 400 for Wi-Fi® gateway and extender placement optimization. The communication system 400 may include a digital transmitter 402, a radio frequency circuit 404, a digital receiver 406, a processing device 408, and a device 412. The digital transmitter 402 and/or the processing device 408 may be configured to receive a baseband signal via a connection 410. In some instances, the digital transmitter 402 and the radio frequency circuit 404 may be a transceiver 414.

In some instances, the communication system 400 may include a system of devices that may be configured to communicate with one another via a wired or wireline connection. For example, a wired connection in the communication system 400 may include one or more Ethernet cables, one or more fiber-optic cables, and/or other similar wired communication mediums. Alternatively, or additionally, the communication system 400 may include a system of devices that may be configured to communicate via one or more wireless connections. For example, the communication system 400 may include one or more devices configured to transmit and/or receive radio waves, microwaves, ultrasonic waves, optical waves, electromagnetic induction, and/or similar wireless communications. Alternatively, or additionally, the communication system 400 may include combinations of wireless and/or wired connections. In these and other examples, the communication system 400 may include one or more devices that may be configured to obtain a baseband signal, perform one or more operations to the baseband signal to generate a modified baseband signal, and transmit the modified baseband signal, such as to one or more loads.

In some instances, the communication system 400 may include one or more communication channels that may communicatively couple systems and/or devices included in the communication system 400. For example, the transceiver 414 may be communicatively coupled to the device 412.

In some instances, the transceiver 414 may be configured to obtain a baseband signal. For example, as described herein, the transceiver 414 may be configured to generate a baseband signal and/or receive a baseband signal from another device. In some examples, the transceiver 414 may be configured to transmit the baseband signal. For example, upon obtaining the baseband signal, the transceiver 414 may be configured to transmit the baseband signal to a separate device, such as the device 412. Alternatively, or additionally, the transceiver 414 may be configured to modify, condition, and/or transform the baseband signal in advance of transmitting the baseband signal. For example, the transceiver 414 may include a quadrature up-converter and/or a digital to analog converter (DAC) that may be configured to modify the baseband signal. Alternatively, or additionally, the transceiver 414 may include a direct radio frequency (RF) sampling converter that may be configured to modify the baseband signal.

In some instances, the digital transmitter 402 may be configured to obtain a baseband signal via the connection 410. In some examples, the digital transmitter 402 may be configured to up-convert the baseband signal. For example, the digital transmitter 402 may include a quadrature up-converter to apply to the baseband signal. In some examples, the digital transmitter 402 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 402.

In some instances, the transceiver 414 may include one or more subcomponents that may be used in preparing the baseband signal and/or transmitting the baseband signal. For example, the transceiver 414 may include an RF front end (e.g., in a wireless environment) which may include a power amplifier (PA), a digital transmitter (e.g., the digital transmitter 402), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., the radio frequency circuit 404) of the transceiver 414 may be synchronized with the resource controller via the S-plane device, which may contribute to high-accuracy timing with respect to a reference clock.

In some instances, the transceiver 414 may be configured to obtain the baseband signal for transmission. For example, the transceiver 414 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 414 may be configured to generate a baseband signal for transmission. In these and other examples, the transceiver 414 may be configured to transmit the baseband signal to another device, such as the device 412.

In some instances, the device 412 may be configured to receive a transmission from the transceiver 414. For example, the transceiver 414 may be configured to transmit a baseband signal to the device 412.

In some instances, the radio frequency circuit 404 may be configured to transmit the digital signal received from the digital transmitter 402. In some examples, the radio frequency circuit 404 may be configured to transmit the digital signal to the device 412 and/or the digital receiver 406. In some examples, the digital receiver 406 may be configured to receive a digital signal from the RF circuit and/or send a digital signal to the processing device 408.

In some instances, the processing device 408 may be a standalone device or system, as illustrated. Alternatively, or additionally, the processing device 408 may be a component of another device and/or system. For example, in some examples, the processing device 408 may be included in the transceiver 414. In instances in which the processing device 408 is a standalone device or system, the processing device 408 may be configured to communicate with additional devices and/or systems remote from the processing device 408, such as the transceiver 414 and/or the device 412. For example, the processing device 408 may be configured to send and/or receive transmissions from the transceiver 414 and/or the device 412. In some examples, the processing device 408 may be combined with other elements of the communication system 400.

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over the network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. An access point (AP), comprising:
a transceiver; and
a processing device operable to:
obtain, from the transceiver, a plurality of received signal strength indicators (RSSIs) from a plurality of devices in an area;
generate a mapping of wireless local area network (WLAN) performance across the area using the plurality of RSSIs; and
generate a user instruction based on the mapping.

2. The AP of claim 1, wherein the processing device is further operable to:
obtain, from the transceiver, channel state information (CSI) data from the plurality of devices in the area; and
generate the mapping of WLAN performance across the area using the CSI data.

3. The AP of claim 1, wherein the processing device is further operable to:
obtain, from the transceiver, beamforming feedback from the plurality of devices in the area; and
generate the mapping of WLAN performance across the area using the beamforming feedback.

4. The AP of claim 1, wherein the processing device is further operable to determine a placement for one or more of the AP or a wireless extender.

5. The AP of claim 4, wherein the processing device is further operable to determine confirmation that the placement has been provided.

6. The AP of claim 1, wherein the processing device is further operable to identify when a change has occurred, wherein the change includes one or more of a new device joining the WLAN, an environmental change, or a usage pattern change.

7. The AP of claim 1, wherein the processing device is further operable to provide the user instruction to a station (STA).

8. The AP of claim 7, wherein the user instruction includes voice-guided feedback.

9. A station (STA), comprising:
a transceiver;
a processing device operable to obtain, from the transceiver and transmitted by an access point (AP), a user instruction based on a mapping of wireless local area network (WLAN) performance across an area, wherein the mapping is based on a plurality of received signal strength indicators (RSSIs) from a plurality of devices in the area; and
a speaker operable to provide the instruction as voice-guided feedback.

10. The STA of claim 9, wherein the mapping is based on channel state information (CSI) data from the plurality of devices in the area.

11. The STA of claim 9, wherein the mapping is based on beamforming feedback from the plurality of devices in the area.

12. The STA of claim 9, wherein the processing device is further operable to verify when placement of one or more of the AP or a wireless extender has been provided.

13. The STA of claim 9, wherein the voice-guided feedback is provided via a phone app.

14. A method, comprising:
receiving, at an access point (AP), a plurality of received signal strength indicators (RSSIs) from a plurality of devices in an area;
generating, at the AP, a mapping of wireless local area network (WLAN) performance across the area using the plurality of RSSIs; and
generating, at the AP, a user instruction based on the mapping.

15. The method of claim 14, further comprising:
receiving, at the AP, channel state information (CSI) data from the plurality of devices in the area; and
generating, at the AP, the mapping of WLAN performance across the area using the CSI data.

16. The method of claim 14, further comprising:
receiving, at the AP, beamforming feedback from the plurality of devices in the area; and
generating, at the AP, the mapping of WLAN performance across the area using the beamforming feedback.

17. The method of claim 14, further comprising determining, at the AP, a placement for one or more of the AP or a wireless extender.

18. The method of claim 17, further comprising determining, at the AP, confirmation that the placement has been provided.

19. The method of claim 14, further comprising identifying, at the AP, when a change has occurred, wherein the change includes one or more of a new device joining the WLAN, an environmental change, or a usage pattern change.

20. The method of claim 14, further comprising providing, at the AP, the user instruction to a station (STA).
